(19) United States
(12) Patent Application Publication
(10) Pub. No.: US 2007/0044514 A1
(43) Pub. Date: Mar. 1, 2007

(54) Glass member and production process thereof

(76) Inventors: Takashi Naitou, Mito (JP); Motoyuki Miyata, Hitachinaka (JP); Hiroyuki Akata, Hitachi (JP); Yuichi Sawai, Hitachi (JP); Osamu Shiono, Hitachi (JP); Tatsumi Hirano, Hitachinaka (JP); Hiroki Yamamoto, Hitachi (JP); Hideto Momose, Hitachiota (JP); Takao Miwa, Hitachinaka (JP); Yuzo Kozono, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/592,158

(22) Filed: Nov. 3, 2006

Related U.S. Application Data
(63) Continuation of application No. 11/224,095, filed on Sep. 13, 2005, now abandoned.

(30) Foreign Application Priority Data
Sep. 17, 2004 (JP) 2004-272228

(51) Int. Cl. C03C 15/00

(52) U.S. Cl. 65/30.14

(57) ABSTRACT

The present invention is envisioned to provide a high-strength glass which is applicable to the objective of size and weight reduction. A layer containing a rare earth element in a high concentration is formed at a glass portion close to a surface (superficial portion) which is shallow in depth from an outermost surface of the glass which contains a rare earth element.

### CROSS-REFERENCE TO RELATED APPLICATION

This application is a continuation application of U.S. application Ser. No. 11/224,095, filed Sep. 13, 2005, the contents of which are incorporated herein by reference.

### FIELD OF THE INVENTION

The present invention relates to a high-strength glass member which is drastically improved in shatter resistance and finds useful application to various kinds of structural members, glass products and other products utilizing glass which are required to maintain shatter resistance even if reduced in size and weight.

### BACKGROUND OF THE INVENTION

Glass is utilized for a very wide variety of articles ranging from tableware, window glass and its sort which are found close to us, to electronic devices such as displays and storages and transportation means such as various kinds of vehicles and aircraft. It has been the general concept that glass is fragile and easily broken, and realization of unbreakable glass has been but a fantasy. As means for strengthening glass, there have been known several methods such as chemical strengthening, air blast cooling and crystallization. Nevertheless, even with the glass which has had such treatments, or so-called strengthened glass, the improvement of strength is limited to approximately double to thrice the strength of the non-treated glass (ordinary glass). In this field of industry, development of high-strength glass having four or more times higher strength than ordinary glass is being pushed ahead for application to flat panel displays (FPD).

It is considered that shatter (break) of glass occurs as the innumerable microcracks existing in the glass surface are forced to grow up to the greater cracks when a flexural stress is exerted thereto. It is impossible to eliminate such microcracks from the glass surface. Therefore, it has been tried to obtain so-called strengthened glass by subjecting ordinary glass to the various strengthening treatments such as mentioned above.

As an example of glass strengthening treatments, Patent Document 1 discloses a chemical treatment in which a rare earth oxide (such as La₂O₃, Y₂O₃ or CeO₂) is incorporated in ordinary glass in an amount of 1% by weight or less. Also, Patent Document 2 discloses a method in which the surface portion of the chemically strengthened glass is subjected to a dealkalization treatment and then the divalent metal ions Zn²⁺ are injected into this surface portion to prevent elution of the alkali ions from the glass surface to thereby inhibit growth of the cracks.

Air blast cooling is a treatment in which cold air is blown against the heated glass surface to form a compression strengthened layer on this glass surface to thereby prevent formation of cracks. This treatment is principally targeted at the large-sized plate glass, 4 mm or greater in thickness, which is mostly used for vehicles or building materials. The crystallization method features forming the crystal grains with a size of 100 nm or greater in the inside of amorphous glass to suppress the growth of the microcracks to the larger cracks in the glass surface by the presence of the crystal grains, thereby to strengthen the whole body of glass.

Patent Document 1: JP-A-2001-302278

Patent Document 2: JP-A-2003-286048

### BRIEF SUMMARY OF THE INVENTION

In the chemical strengthening method which is a conventional concept of means for strengthening glass, the glass surface is subjected to alkali ion exchange for replacing Li ions in the surface portion of ordinary glass with Na ions, and the Na ions in the surface portion of ordinary glass with K ions, in a heat-melted nitrate to form a compression strengthened layer on the glass surface. “Unbreakable glass” is required to have strength which is several to 10 times that of ordinary glass as a result of the strengthening treatments. The strength enhancing effect by the conventional chemical treatments, however, is limited to about double or thrice higher strength than ordinary glass and far from being capable of providing “unbreakable glass”. Further, such strengthened glass involves the problem of low heat resistance (drop of strength on heating). Also, strength of the “strengthened glass” obtained by the conventional crystallization treatment is only about double that of ordinary glass, and such “strengthened glass” is low in transparency. As viewed above, it has been hardly possible to realize unbreakable glass with the prior art technology.

An object of the present invention is to provide a high-strength glass which is applicable to the scheme for size and weight reduction. The high-strength glass according to the present invention is capable of realizing enhancement of strength by about 6 to 10 times over the ordinary glass and finds its useful application to a wide variety of articles such as mentioned above including substrates for FPD, various kinds of glass-utilizing products, building materials, etc.

In order to attain the above object, the present invention features forming a high-concentration rare earth element-containing layer (which may hereinafter be called simply as high-concentration layer) at a superficial (surface) portion of the glass member or at a portion of the glass member close to the surface which is shallow in depth from an outermost surface of the glass member. The concentration of the rare earth element in this high-concentration layer is made higher than that in the inside middle portion of the glass greater in depth than the said shallow surface portion. Here, the glass portion close to the surface (superficial portion) which is shallow in depth from the outermost surface of the glass may be simply called “surface portion”, and the inside middle portion greater in depth than the said surface portion from the outermost surface of the glass may be called “inside portion”.

The glass according to the present invention contains as a rare earth element at least one of Pr, Nd, Sm, Eu, Gd, Tb, Dy, Ho, Er, Tm, Yb and Lu, preferably at least one of Eu, Gd, Dy, Tm, Yb and Lu, more preferably Gd.

In the glass of the present invention, a rare earth element is contained in an amount of 1 to 10% by weight, preferably 2 to 7% by weight calculated as an oxide thereof Ln₂O₃ (Ln: rare earth element) based on the whole glass.

The production process of the glass member according to the present invention comprises at least:

the step of forming a film of coating in which a base glass is dipped in a rare earth metal solution prepared by dissolving an organic compound of a rare earth metal in an organic solvent to coat a surface of the base glass with the said rare earth metal solution to thereby form a rare earth metal coating film; and

the heating and diffusing step in which the base glass having said rare earth metal coating film formed on its surface is heated to diffuse the rare earth element into a surface portion of the base glass or into a glass portion close to the surface which is shallow in depth from an outermost surface of the glass while forming a coating of a rare earth oxide film on said surface of the glass member.

In the film forming step in the glass production process according to the present invention, the rare earth metal solution in which the base glass is dipped is brought into a reduced pressure state and a normal pressure state in turn repeatedly to form the desired coating film.

Also, a rare earth element may or may not be contained in the base glass used in the present invention.

By increasing the concentration of the rare earth element in the surface portion of the glass, the surface portion is strengthened remarkably, and the microcracks therein are prevented from growing to the larger cracks when a flexural stress is exerted to the glass. Use of a rare earth element is effective for strengthening glass. As such a rare earth element, Pr, Nd, Sm, Eu, Gd, Tb, Dy, Ho, Er, Tm, Yb and Lu can be used, of which Eu, Gd, Dy, Tm, Yb and Lu are preferred, with Gd being more preferred. The glass containing Eu, Gd, Dy, Tm, Yb or Lu has high light transmittance in the visible light region, and particularly the glass containing Gd is capable of satisfying, quite remarkably, both requirements for enhanced strength and high light transmittance in the visible light region.

In the present invention, a rare earth element such as mentioned above is contained in an amount of 1 to 10% by weight, preferably 2 to 7% by weight calculated as an oxide thereof Ln₂O₃ (Ln: rare earth element) based on the whole glass. If its content is less than 1% by weight, its strength improving effect is small, and if its content exceeds 10% by weight, the treated glass tends to devitrify (crystallize). Therefore, the preferred range of content of the rare earth element is 2 to 7% by weight.

The scope of use of the present invention is not limited to the structural components of the display devices and the glass structural members of electronic devices such as substrates of magnetic discs; the invention can be also applied widely to the other objectives such as structural materials and window glass (including two-layer glass and laminated glass) of buildings, substrates for solar batteries, structural members and window glass of vehicles, aircraft, spacecraft, etc., for which high strength and reduction of size and weight are essential requirements.

Other objects, features and advantages of the invention will become apparent from the following description of the embodiments of the invention taken in conjunction with the accompanying drawings.

### BRIEF DESCRIPTION OF THE DRAWINGS

FIG. 1 is drawing illustrating the means for the glass strengthening treatment according to the present invention.

FIG. 2 is a diagrammatic illustration of the glass strengthening mechanism according to the present invention.

FIG. 3 is a schematic sectional view of a principal part of the high-strength glass member obtained by forming a rare earth element high-concentration layer at the surface portion of a base glass containing no rare earth element.

FIG. 4 is a drawing illustrating the layout for the flexural strength test using a test piece.

FIG. 5 is a graph illustrating the test results on average flexural strength according to the type of the rare earth element in the rare earth oxide film formed as glass coating.

FIG. 6 is a schematic sectional view of a principal part of the high-strength glass obtained by forming a rare earth element high-concentration layer at the surface portion of a base glass containing a rare earth element in a low concentration.

FIG. 7 is a graph illustrating the test results on average flexural strength according to the type of the rare earth element of the rare earth element film coating the base glass containing a rare earth element in a low concentration.

FIG. 8 is a schematic sectional view of a principal part of the high-strength glass obtained by forming a relatively thick rare earth element high-concentration layer at the surface portion of the base glass containing a rare earth element in a low concentration.

FIG. 9 is graph illustrating the test results on average flexural strength according to the type of the rare earth element in the glass obtained by forming a relatively thick rare earth element high-concentration layer on the base glass containing a rare earth element.

FIG. 10 is a graph showing the results of the average flexural strength test on a test piece having formed in its surface portion a rare earth element high-concentration layer by applying a magnetic field and a test piece to which no magnetic field was applied.

FIG. 11 is a graph showing the results of the average flexural strength test on a test piece to which a magnetic field was applied and a test piece to which no magnetic field was applied, in relation to the content of the rare earth element (Gd₂O₃).

FIG. 12 is a graphic illustration of the relation of average flexural strength to heat treatment temperature.

FIG. 13 is a schematic plan illustrating the makeup of FED using the glass according to the present invention.

FIG. 14 is a perspective view showing the general structure of FED illustrated in FIG. 13.

FIG. 15 is a sectional view of FIG. 14.

### DESCRIPTION OF REFERENCE MARKS

HIG: high strength glass, RRL: high-concentration layer, MC: microcrack, UIG: ultra-high strength glass, NR: glass containing no rare earth element, RP: glass containing a rare earth element, PNL1: back panel, PNL2: front panel, SUB1: back substrate, SUB2: front substrate, s (s1, s2, . . . sm): scanning signal lines, d (d1, d2, d3, . . . ): picture signal lines, ELS: electron source, ELC: connecting electrode, AD: anode, BM: black matrix, PH (PH(R), PH(G), PH(B)): phosphor layer, SDR: scanning signal line drive circuit, DDR: picture signal line drive circuit, SPC: spacer.

### DETAILED DESCRIPTION OF THE INVENTION

The best mode for carrying out the present invention is described below.

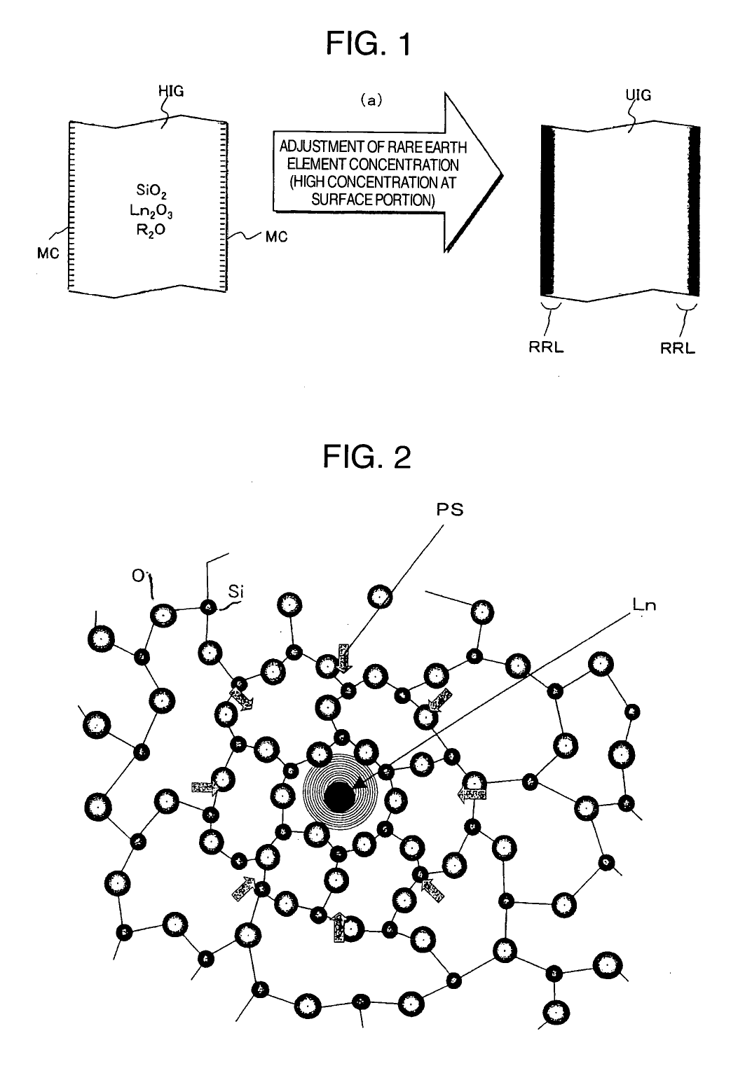

FIG. 1 is a diagrammatic drawing illustrating the means for glass strengthening treatment according to the present invention. In FIG. 1, glass is shown by a partial section, and in the drawing, both right and left sides of each section are the surfaces. The main component of ordinary glass is silicon oxide (SiO₂), so that it is called oxide-based glass. In the present invention, as shown in FIG. 1, the concentration of the rare earth element (rare earth oxide (Ln₂O₃)) in the base glass HIG comprising silicon oxide SiO₂ is adjusted to form a rare earth element high-concentration layer RRL at the surface portion of the glass. That is, the rare earth element concentration in the surface portion was made higher than that in the inside portion.

Here, by adding a rare earth oxide (Ln₂O₃) in the base glass, the whole body of the glass was strengthened to provide a high-strength glass HIG, and the concentration of this rare earth element was increased in the surface portion to form a high concentration layer RRL. The presence of this high concentration layer RRL serves for preventing break of the glass due to the microcracks MC existing in the glass surface. According to the present invention, there can be obtained ultra-high strength glass, or so-called “unbreakable glass” UIG, which has 6 to 12 times or even more times higher strength than ordinary glass.

The rare earth oxide added to the high-strength glass HIG is an oxide (Ln₂O₃) of Pr, Nd, Sm, Eu, Gd, Tb, Dy, Ho, Er, Tm, Yb or Lu, preferably an oxide (Ln₂O₃) of at least one element selected from the group of Eu, Gd, Dy, Tm, Yb and Lu, more preferably an oxide of Gd. By containing such a rare earth oxide in the glass, it is possible to realize high strengthening of the whole body of the glass, and by forming a high concentration layer RRL on both sides of the glass, there can be obtained a glass with extremely high strength.

Instead of using a high-strength glass HIG containing a rare earth oxide such as mentioned above, the surface of the base glass containing no rare earth oxide may be coated with a rare earth element and subjected to a heat treatment to cause diffusion of the rare earth element, thereby forming a high concentration layer RRL at the surface portion.

Specifically, the base glass is dipped in a rare earth metal solution prepared by dissolving an organic compound of a rare earth metal in an organic solvent to coat the surface of said base glass with the rare earth metal solution to form a rare earth metal coating film. Then the base glass having such a rare earth metal coating on the surface is heated to let the rare earth element diffuse to the glass portion close to the surface which is shallow in depth from the outermost surface of the glass (that is, the surface portion) to form a coat of a rare earth oxide film on the glass surface. In this coating film forming step, the rare earth metal solution in which the base glass is dipped is brought into a reduced pressure state and a normal pressure state in turn repeatedly.

FIG. 2 is a diagrammatic illustration of the glass strengthening mechanism by incorporation of a rare earth element in the glass according to the present invention. The main component of the glass is SiO₂, and the glass has an oxygen skeletal structure shown in FIG. 2. It is considered that when a rare earth oxide Ln₂O₃ is added in this structure, the oxygen atoms O in the oxygen skeletal structure are attracted by the electric field of the added rare earth element Ln as shown by an arrow mark PS to thereby strengthen the whole body of the glass.

A rare earth element high-concentration layer RRL is formed at the surface portion of the high-strength glass HIG strengthened in its whole body by the incorporation of a rare earth oxide Ln₂O₃. By this, the surface of the glass is highly strengthened and an ultra-high strength glass UIG proof against shattering caused by the microcracks can be obtained. In the following, the various effects brought about by the incorporation of a rare earth element in the ultra-high strength glass of the present invention are explained.

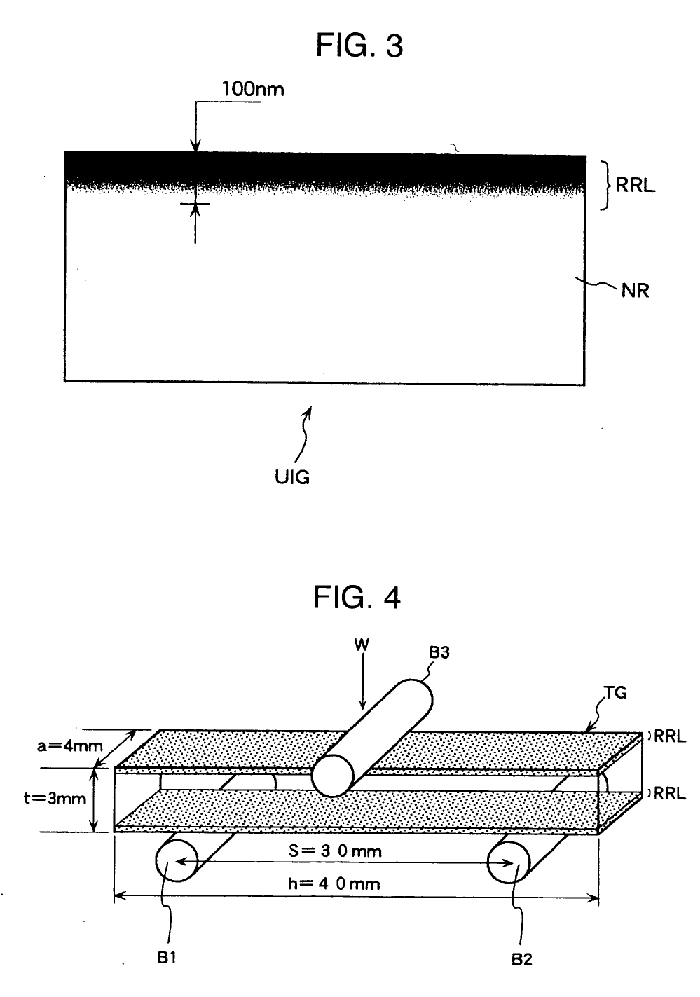

FIG. 3 is a schematic sectional view of a principal part of the high-strength glass obtained by forming a high-concentration rare earth element layer at the surface portion of a base glass containing no rare earth element. In FIG. 3 is shown only a half of the high-strength glass UIG on its frontal surface side. A layer containing a rare earth element in a high concentration (high concentration layer) RRL is formed at the surface portion through a span of approximately 100 nm in the direction of thickness from the outermost surface of the base glass NR containing no rare earth element. Confirmation of this high concentration layer RRL was made by observing the above-mentioned glass section by an electron microscope.

In order to confirm the strength improving effect by formation of the said high concentration layer RRL of the high-strength glass UIG shown in FIG. 3, the test pieces were made from a glass block described below and subjected to a strength (flexural strength) test.

(1) Making of Glass Block

Base glass composition: 65 wt % SiO₂, 6 wt % Li₂O, 9 wt % Na₂O, 2 wt % K₂O, 16 wt % Al₂O₃ and 2 wt % ZnO.
Base glass Materials: SiO₂, Li₂CO₃, Na₂CO₃, KNO₃, Al₂O₃ and ZnO.
Amount of the materials melted: about 3 kg.
Melting conditions: The materials were melted at 1,500-1,600° C. for 3 hours of which 2 hours was used for stirring (glass homogenization). The melt was cast into a mold to make a glass block, and the block was cooled at 550° C. over a period of 3 hours (gradually cooled at a cooling rate of 1 ° C./min)
   (2) Preparation of Test Pieces (According to JIS R1601)

The 3 mm×4 mm×40 mm test pieces were made from the said glass block. Each test piece was dipped in a solution prepared by dissolving an organic compound of a rare earth metal in an organic solvent, and after bringing the solution into a reduced pressure condition and a normal pressure condition in turn repeatedly, the surface of the test piece was coated with the said rare earth metal solution to form a rare earth metal coating film. This was heated at 530° C. for one to 2 hours to let the rare earth element diffuse into the glass portion close to the surface which is shallow in depth from the outermost surface of the glass (namely surface portion) while forming a coat of a rare earth oxide film on the glass surface. Here, Pr, Nd, Sm, Eu, Gd, Tb, Dy, Ho, Er, Tm, Yb and Lu were used as the rare earth elements.

(3) Flexural Strength Test

FIG. 4 illustrates the layout of the flexural strength test using a test piece. In this flexural strength test, as shown in FIG. 4, there are used two lower columns B1, B2 arranged parallel to and spaced apart from each other by a span s, and an upper column B3 disposed at a higher level than and parallel to the lower columns B1, B2 and positioned halfway between these lower columns. Here, the span s between the lower columns B1, B2 is set at 30 mm, and the test piece TG is placed above the two lower columns B1, B2 with the earth element high-concentration layers RRL facing both upwards and downwards. The upper column B3 is positioned at a halfway point on the upper side of the test piece TG, and a load is applied in the direction of arrow W. The load at break of the test piece TG is expressed by w, and the flexural strength is calculated from the following equation (1).
σ=(3s·w/2a·t²) (1)

wherein σ (MPa): 3-point bending strength; s: span of the lower portion; w: breaking load; a: width of the test piece; t: thickness of the test piece.

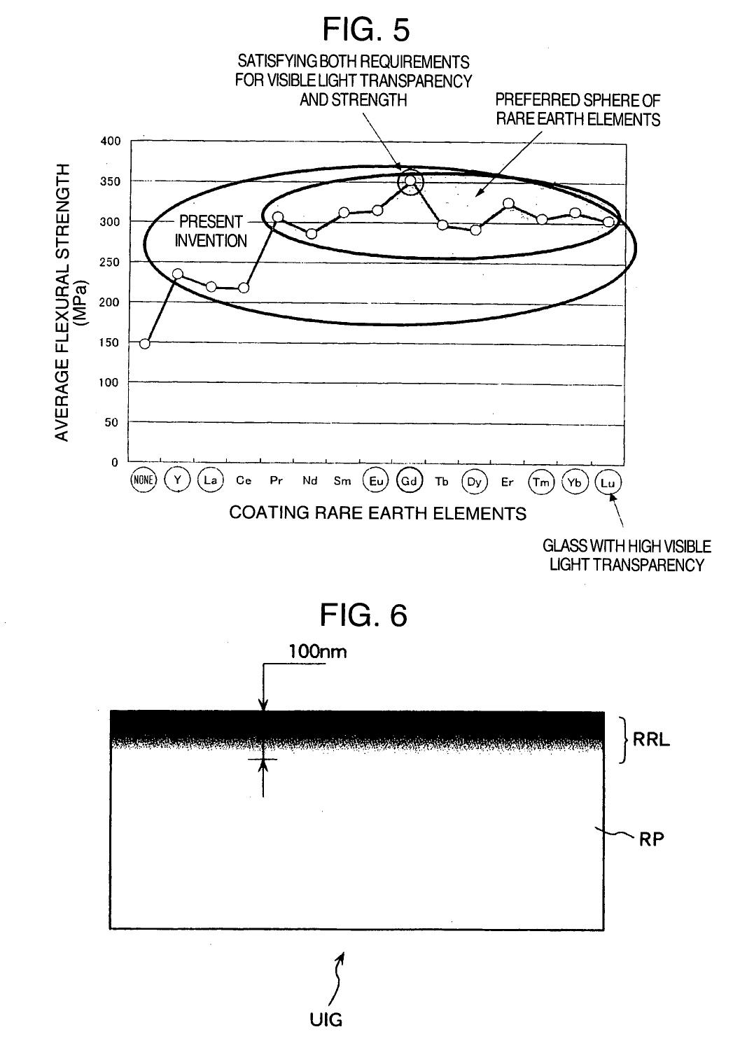

FIG. 5 is a graph showing the test results on average flexural strength according to the type of the rare earth element in the rare earth oxide coating film. The average flexural strength of the glass samples with no coating with a rare earth oxide film was also shown under the caption of “none” with encirclement by ◯. The average flexural strength of the glass samples with “none” is 150 MPa. On the other hand, as indicated by enclosure with a larger oval in FIG. 5, the glass samples with a rare earth oxide film coating have a high average flexural strength which exceeds 200 MPa. Also, the glass samples using the rare earth elements encircled with ◯ have high visible light transparency.

Particularly, the glass samples having a rare earth element high-concentration layer RRL formed at the surface portion by using the rare earth elements (Pr, Nd, Sm. Eu, Gd, Tb, Dy, Ho, Er, Tm, Yb and Lu) in the sphere defined by a smaller oval in FIG. 5 are markedly improved in average flexural strength. Especially the glass using Gd is capable of satisfying, most remarkably, both requirements for visible light transparency and average flexural strength.

FIG. 6 is a schematic sectional view of a principal part of a high-degree glass produced by forming a rare earth element high-concentration layer at the surface portion of a base glass containing a rare earth element in a low concentration. In FIG. 6 is shown only a half of the high-strength glass UIG on its frontal surface side. A layer containing a rare earth element in a high concentration (high-concentration layer) RRL is formed at the surface portion through a span of approximately 100 nm in the direction of thickness from the outermost surface of the base glass NR containing a rare earth element (Gd) in a low concentration. Confirmation of this high-concentration layer RRL was made by observing the above-mentioned glass section by an electron microscope.

In order to confirm the strength improving effect by formation of the said high-concentration layer RRL in the high-strength glass UIG shown in FIG. 6, the test pieces were made from a glass block described below and subjected to a strength (flexural strength) test.

(1) Making of Glass Block

Base glass composition: 65 wt % SiO₂, 6 wt % Li₂O, 7 wt % Na₂O, 2 wt % K₂O, 15 wt % Al₂O₃, 2 wt % ZnO and 3 wt % Gd₂O₃ (Gd: rare earth element).
Base glass materials: SiO₂, Li₂CO₃, Na₂CO₃, KNO₃, Al₂O₃, ZnO and Gd₂O₃. (0.2 wt % of Sb₂CO₃ was added as clearer)
Amount of the materials melted: about 3 kg.
Melting conditions: The materials were melted at 1,500-1,600° C. for 3 hours of which 2 hours was used for stirring (glass homogenization). The melt was cast into a mold to make a glass block, and the block was cooled at 550° C. over a period of 3 hours (gradually cooled at a cooling rate of 1° C./min).
   (2) Preparation of Test Pieces (According to JIS R1601)

The 3 mm (thickness)×4 mm (width)×40 mm (length) test pieces were made from the said glass block. Each test piece was dipped in a solution prepared by dissolving an organic compound of a rare earth metal in an organic solvent, and after bringing the solution into a reduced pressure condition and a normal pressure condition in turn repeatedly, the surface of the test piece was coated with the said rare earth metal solution to form a coat of a rare earth metal film. This was heated at 530° C. for one to 2 hours to let the rare earth element diffuse into the glass portion close to the surface which is shallow in the direction of depth from the outermost surface of the glass (namely surface portion) while coating the glass surface with a rare earth oxide film. Here, Pr, Nd, Sm, Eu, Gd, Tb, Dy, Ho, Er, Tm, Yb and Lu were used as the rare earth elements.

(3) Flexural Strength Test

The flexural strength test was conducted by using the same layout as illustrated in FIG. 4.

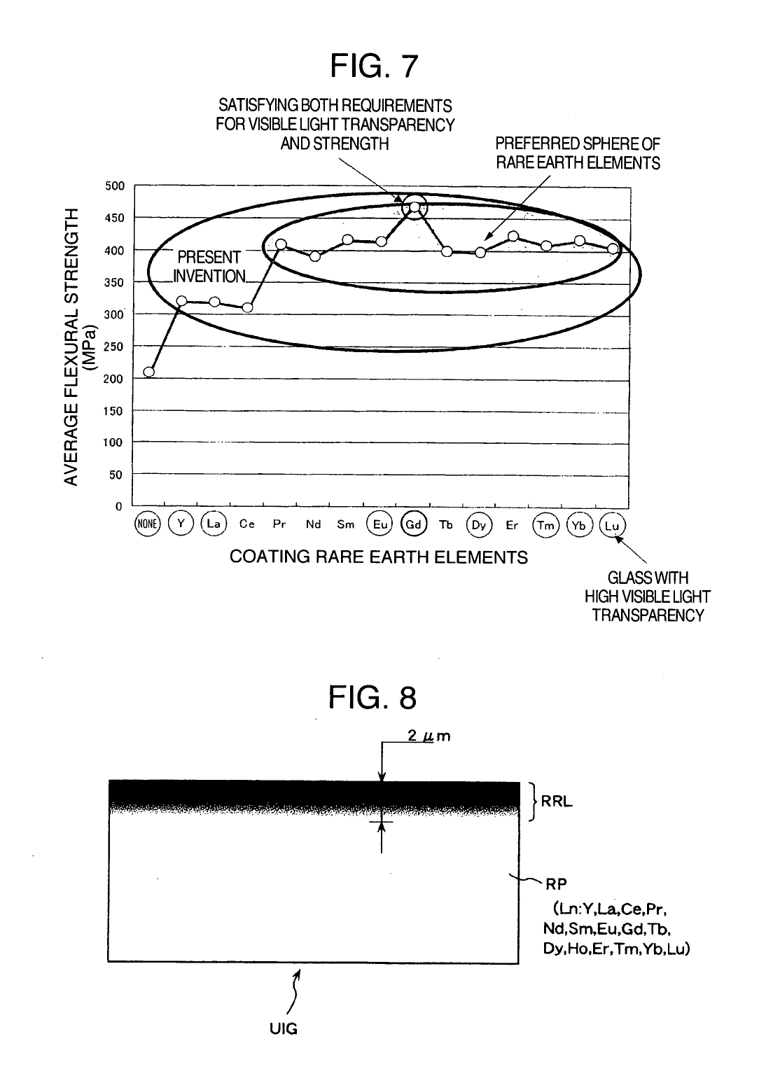

FIG. 7 is a graph showing the test results on average flexural strength according to the type of the rare earth element in the rare earth oxide film coating the base glass containing a rare earth element in a low concentration. The average flexural strength of the glass samples with no coating with a rare earth oxide film was also shown under the caption of “none” with encirclement by ◯. The average flexural strength of the glass samples with “none” slightly exceeds 200 MPa. On the other hand, as indicated by enclosure with a larger oval in FIG. 7, the glass samples with a coat of a rare earth oxide film have a high average flexural strength which exceeds 300 MPa. Also, the glass samples using the rare earth elements encircled with ◯ have high visible light transparency.

Particularly, the glass samples having a rare earth element high-concentration layer RRL formed at the surface portion by using the rare earth elements (Pr, Nd, Sm, Eu, Gd, Tb, Dy, Ho, Er, Tm, Yb and Lu) in the sphere defined by a smaller oval in FIG. 5 are markedly improved in average flexural strength. Especially the glass using Gd is capable of satisfying, most remarkably, both requirements for visible light transparency and average flexural strength.

FIG. 8 is a schematic sectional view of a principal part of a high-degree glass produced by forming a relatively thick rare earth element high-concentration layer at the surface portion of a base glass containing a rare earth element in a low concentration. In FIG. 8 is shown only a half of the high-strength glass UIG on its frontal surface side. A layer containing a rare earth element in a high concentration (high-concentration layer) RRL is formed at the surface portion through a span of approximately 2 μm in the direction of thickness from the outermost surface of the base glass NR containing a rare earth element. Confirmation of this high concentration layer RRL was made by observing the above-mentioned glass section by an electron microscope.

In order to confirm the strength improving effect by formation of the said high-concentration layer RRL in the high-strength glass UIG shown in FIG. 8, the test pieces were made from a glass block described below and subjected to a strength (flexural strength) test.

(1) Making of Glass Block

Base glass composition: 65 wt % SiO₂, 6 wt % Li₂O, 7 wt % Na₂O, 2 wt % K₂O, 15 wt % Al₂O₃, 2 wt % ZnO and 3 wt % Ln₂O₃ (Ln: rare earth element).
Base glass materials: SiO₂, Li₂CO₃, Na₂CO₃, KNO₃, Al₂O₃, ZnO and Ln₂O₃. (Ce alone was used in the form of CeO₂, and 0.2 wt % of Sb₂CO₃ was added as clearer).
Amount of the materials melted: About 300 g of each of the glass samples containing Y, La, Ce, Pr, Nd, Sm, Eu, Gd, Tb, Dy, Ho, Er, Tm, Yb and Lu, respectively, was prepared.
Melting conditions: The materials were melted at 1,500-1,600° C. for 1.5 hour of which 0.5 hour was used for stirring (glass homogenization). The melt was cast into a mold to make a glass block, and the block was cooled at 550° C. over a period of one hour (gradually cooled at a cooling rate of 1° C./min).
   (2) Preparation of Test Pieces (According to JIS R1601)

The 3 mm (thickness)×4 mm (width)×40 mm (length) test pieces were prepared from the said glass block, and they were dipped in a rare earth ion-containing solution (erbium nitrate [Er(NO₃)₃] at 450° C. for 4 hours.

(3) Flexural Strength Test

The flexural strength test using the above test pieces was conducted with the layout shown in FIG. 4.

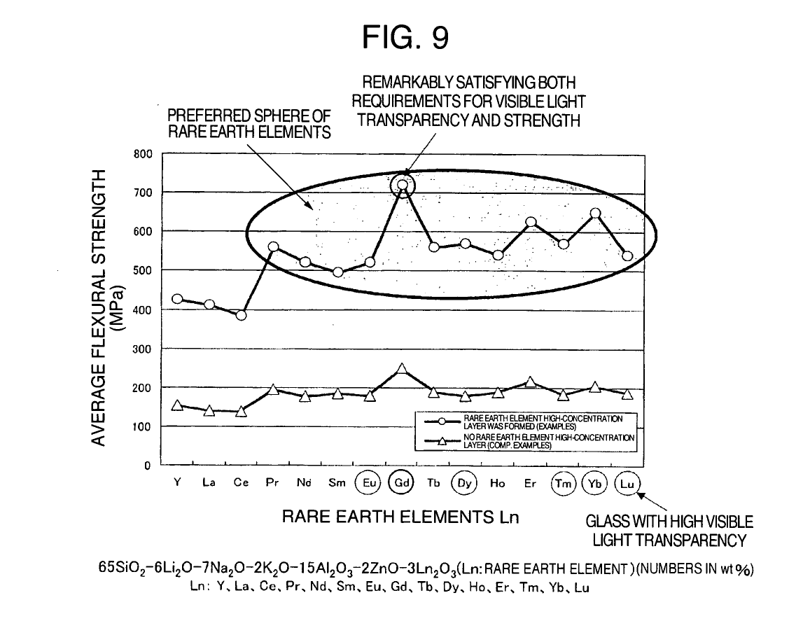

FIG. 9 is a graph showing the test results on average flexural strength, according to the type of the rare earth element used, of the glass samples having a relatively thick rare earth element high-concentration layer formed on the base glass containing a rare earth element. A similar test was also conducted on the glass samples having no such a rare earth element high-concentration layer, and the result is shown by a graph connecting the plots of A in FIG. 9. Average flexural strength of the glass samples having no high-concentration layer is around 200 MPa, while that of the glass samples having a rare earth element high-concentration layer is around 400 MPa. Also, as indicated by enclosure with an oval in FIG. 9, the glass samples having the said layer using Pr, Nd, Sm, Eu, Gd, Tb, Dy, Ho, Er, Tm, Yb or Lu show average flexural strength of 500 MPa or higher.

Particularly the glass samples using the rare earth elements (Eu, Gd, Dy, Tm, Yb and Lu) encircled with ◯ have high visible light transparency, and especially the glass sample using Gd is capable of satisfying, quite remarkably, both requirements for visible light transparency and high average flexural strength.

Next, an exemplification of average flexural strength of the glass samples which involved melting by overheating under application of a magnetic field in the preparation of the test pieces is explained. The rare earth element is contained in the base glass as plus ions. Here, the following base glass composition and glass materials were used.
(1) Base glass composition: 62 wt % SiO₂, 6 Li₂O, 7 wt % Na₂O, 2 wt % K₂O, 15 wt % Al₂O₃, 2 wt % ZnO and 6 wt % Ln₂O₃ (Ln: rare earth element).
Base glass materials: SiO₂, Li₂CO₃, Na₂CO₃, KNO₃, Al₂O₃, ZnO and Ln₂O₃ (Ln: Gd, Tb or Er; 0.2 wt % of Sb₂CO₃ was added as clearer).
Amount of the materials melted: about 300 g for each of the glass samples containing Gd, Tb and Er.
Melting conditions: Melted at 1,500-1,600° C. for 1.5 hour of which 0.5 hour was used for stirring (glass homogenization).

The melt was cast into a 500° C. mold so that the molding would have a thickness of 3 mm, and the mold holding the melt was immediately put into a 630° C. furnace under application of a magnetic field and, after kept in this state for 2 hours, gradually cooled at a cooling rate of 1° C./min to make a 3 mm thick glass sheet. This was compared with the test pieces which were made without applying the magnetic field.

(2) Preparation of Test Pieces (According to JIS R1601)

A 3 mm (thickness)×4 mm (width)×40 mm (length) test piece was made from each of said glass sheets so that the surface of the glass sheet would become the surface of the test piece. An approximately 100 μm thick rare earth element high-concentration layer was formed at the surface portion of each test piece.

(3) Flexural Strength Test

The flexural strength test was conducted with the same layout as illustrated in FIG. 4 using the above test pieces.

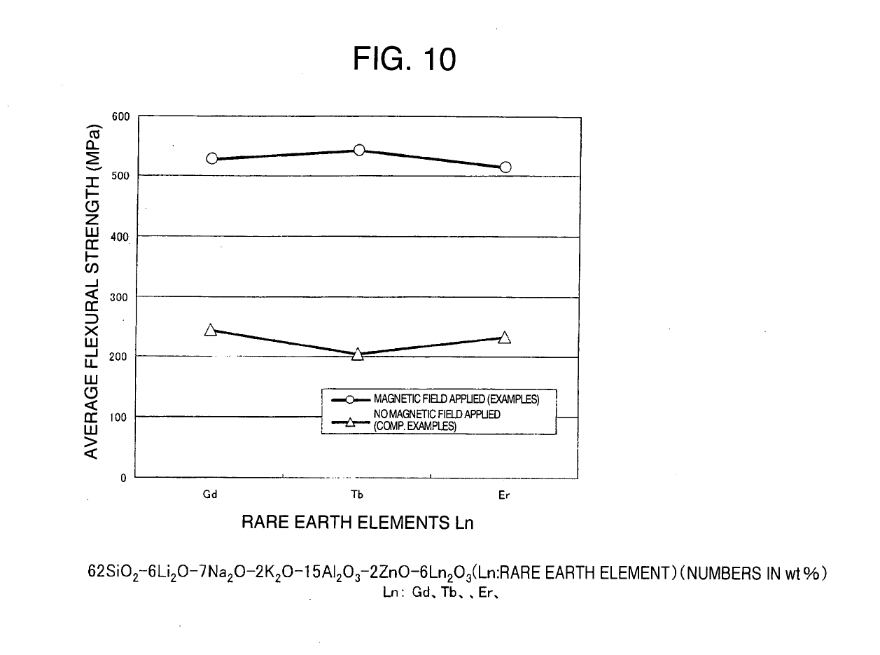

FIG. 10 is a graph showing the results of the average flexural strength test conducted on the test pieces having a rare earth element high-concentration layer formed at the surface portion by applying a magnetic field and the test pieces with their high-concentration layer formed without applying the magnetic field. The test pieces having the high-concentration layer formed without applying a magnetic field had a flexural strength of about 200 to 250 MPa as shown by the graph connecting the plots of A (indicated as Comp. Examples). On the other hand, in the case of the test pieces having a rare earth element high-concentration layer formed at the surface portion by applying a magnetic field, their flexural strength was over 500 MPa as shown by the graph connecting the plots of ◯ in FIG. 10 (indicated as Examples).

A second exemplification of average flexural strength of the glass samples which involved melting by overheating under application of a magnetic field in the preparation of the test pieces is explained. Gd was used as the rare earth element, and its content was changed up to 16% by weight stepwise with a variation of 2% at one time. The base glass composition and the glass materials used here were as follows.
(1) Base glass composition: (68−x) wt % SiO₂, 15 wt % Al₂O₃, 2 wt % ZnO, 6 wt % Li₂O, 7 wt % Na₂O, 2 wt % K₂O and x wt % Gd₂O₃.
Base glass materials: SiO₂, Al₂O₃, ZnO, Li₂CO₃, Na₂CO₃, KNO₃ and Gd₂O₃ (0.2 wt % of Sb₂CO₃ was used as clearer).
Amount of the materials melted: about 300 g of glass was made for each concentration of Gd.
Melting conditions: Melted at 1,500-1,600° C. for 1.5 hour of which 0.5 hour was used for stirring (glass homogenization).

The melt was cast into a 500° C. mold so that the molding would have a thickness of 3 mm, and the mold holding the melt was immediately put into a 630° C. furnace under application of a magnetic field and, after kept in this state for 2 hours, gradually cooled at a cooling rate of 1° C./min to make a 3 mm thick glass sheet.

(2) Preparation of Test Pieces (According to JIS R1601)

A 3 mm (thickness)×4 mm (width)×40 mm (length) test piece was made from the glass sheet of each concentration so that the surface of the glass sheet would become the surface of the test piece. An approximately 100 μm thick rare earth element high-concentration layer was formed at the surface portion of each test piece.

(3) Flexural Strength Test

The above test pieces were subjected to a flexural strength test with the same layout as illustrated in FIG. 4.

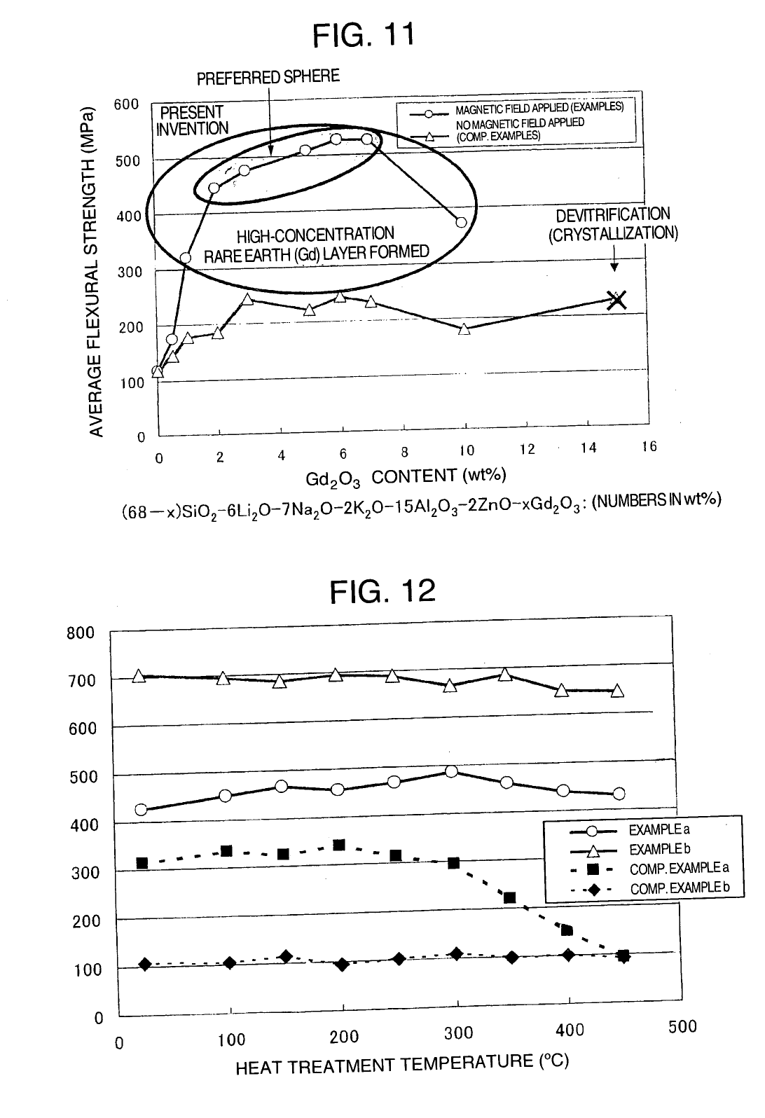

FIG. 11 is a graphic illustration of the results of the average flexural strength test with various contents of the rare earth element (Gd₂O₃) conducted on the test pieces made by applying a magnetic field and the test pieces made without applying a magnetic field. In the case of the test pieces with no magnetic field applied, as shown by a graph connecting the plots of A in the drawing (indicated as Comp. Examples), their flexural strength fell short of 300 MPa and devitrification took place when the Gd content came close to 15% by weight. On the other hand, in the case of the test pieces with a magnetic field applied, as shown by a graph connecting the plots of ◯ in the drawing (indicated as Examples), their flexural strength was higher than 300 MPa at a Gd content in the range of around 1 to 10% by weight (enclosed by a larger oval), and their flexural strength became 450 MPa or higher when the Gd content was in the range of 2 to 7% by weight (enclosed by a smaller oval).

Next, heat resistance of the glass according to the present invention is explained. In the glass which has undergone the chemical strengthening treatment (alkali ion exchange) which is one of the conventional glass surface strengthening means, the alkali ions are diffused to the surface when heated to 300° C. or above to cause a reduction of glass strength. Such reduction of strength on heating can be prevented by forming a rare earth element high-concentration layer at the surface portion according to the present invention. This is particularly effective in application to the structural members for the devices which require a heat treatment in their production process, such as flat panel displays (FPD) and magnetic discs.

The glass compositions used in the heat resistance improvement test were as follows.

Glass A: 65 wt % SiO₂, 6 wt % Li₂O, 7 wt % Na₂O, 2 wt % K₂O, 15 wt % Al₂O₃, 2 wt % ZnO and 3 wt % Gd₂O₃,

Glass B: 71 wt % SiO₂, 2 wt % Li₂O, 13 wt % Na₂O, 1 wt % K₂O, 1 wt % Al₂O₃, 3 wt % MgO and 9 wt % CaO.

Glass materials: SiO₂, Li₂CO₃, Na₂CO₃, KNO₃, Al₂O₃, ZnO, Gd₂O₃, MgCO₃ and CaCO₃ (Sb₂O₃ was added in an amount of 0.5% by weight as clearer).
Amount of the materials melted: about 3 kg for each glass sample.
Melting conditions: 1,500-1,600° C. and 3 hours (of which 0.5 hour was used for stirring—glass homogenization).

The melt was cast into a mold to make a glass block, and it was overheated at 550° C. for one hour, then gradually cooled at a cooling rate of 1° C./min and straightened.
Test piece size: 3 mm in thickness (t), 4 mm in width (a) and 40 mm in length (h).

The test pieces were strengthened as follows.

A high-concentration rare earth element-containing layer was formed on glass A in the manner illustrated in FIG. 6, and this was presented as Example a.

A high-concentration rare earth element-containing layer was formed on glass B in the manner illustrated in FIG. 8, which was presented as Example b.

Alkali ion exchange (chemical strengthening treatment) was conducted to form a 80-100 μm compression stress layer on glass B (presented as Comparative Example a).

No strengthening treatment was conducted on glass B (presented as Comparative Example b).

The heat treatment of the test pieces was conducted at 100° C., 150° C., 200° C., 250° C., 300° C., 350° C., 400° C. and 450° C., each for 10 minutes. 5 test pieces were prepared for the test at each treatment temperature. The flexural strength test conditions were the same as explained above with reference to FIG. 4.

FIG. 12 is a graph illustrating the relation between heat treatment temperature and average flexural strength, and shows the results of the tests on “Example a”, “Example b”, “Comparative Example a” and “Comparative Example b”. In FIG. 12, almost no influence of heating is seen in “Example a” and “Example b”. The rare earth element high-concentration layer at the surface portion of the test pieces is hardly eliminable by the heat treatment, so that there scarcely takes place a reduction of strength. By the present invention, both requirements for high strength and heat resistance can be met.

In “Comparative Example a”, on the other hand, a sharp drop of strength occurs at 300° C. or above. This is caused as the alkali ions after ion exchange by the heat treatment are diffused to the surface. “Comparative Example b” remains unaffected in strength by heating, but this case is out of the question because it is low in strength from the beginning.

A steel ball drop test on the glass samples according to the present invention is now explained. The compositions of the glass samples used for this test were as follows.

Glass C: 67 wt % SiO₂, 4 wt % Li₂O, 8 wt % Na₂O, 1 wt % K₂O, 15 wt % Al₂O₃, 2 wt % ZnO and 3 wt % Gd₂O₃.

Glass D: 62 wt % SiO₂, 6 wt % Li₂O, 7 wt % Na₂O, 2 wt % K₂O, 15 wt % Al₂O₃, 2 wt % ZnO and 6 wt % Gd₂O₃.

Glass E: 71 wt % SiO₂, 2 wt % Li₂O, 14 wt % Na₂O, 3 wt % MgO and 10 wt % CaO.

Glass F: 62 wt % SiO₂, 5 wt % Al₂O₃, 4 wt % Na₂O, 8 wt % K₂O, 4 wt % MgO, 4 wt % CaO, 9 wt % SrCO₃ and 4 wt % BaO.

Glass materials: SiO₂, Li₂CO₃, Na₂CO₃, KNO₃, Al₂O₃, ZNO, Gd₂O₃, MgCO₃, CaCO₃, SrCO₃ and BaCO₃ (0.5% by weight of Sb₂O₃ was added as clearer).
Amount of the materials melted: about 10 kg for each glass sample.
Melting conditions: 1,500-1,600° C. and 5 hours (of which 3 hours was used for stirring for glass homogenization).

The melt was made into a 150 mm wide and 2.5 mm thick glass sheet, and this glass sheet was cut into a 150 mm×150 mm square piece, heated at 550-650° C. for 2 hours, then gradually cooled at a cooling rate of 1° C./min and straightened.

The thus obtained 150 mm×150 mm square and 2.5 mm thick glass sheets were subjected to optical polishing to make the test pieces, and these test pieces were subjected to the strengthening treatments described below.

A rare earth element (Gd) high-concentration layer same as illustrated in FIG. 6 was formed on glass C . . . “Example c”

A rare earth element (Er) high-concentration layer same as illustrated in FIG. 8 was formed on glass D . . . “Example d”

A rare earth element (Gd) high-concentration layer same as in the first exemplification involving magnetic field application was formed on glass D . . . “Example e”

A chemical strengthening treatment (alkali ion exchange) was conducted on glass E to form a 80-100 μm thick compression stress layer . . . “Comparative Example c”

Glass E with no treatment . . . “Comparative Example d”

Glass F with no treatment . . . “Comparative Example e”

An impact test was conducted on the glass samples according to JIS C8917, in which a steel ball with a mass of 450 g was dropped to each test piece of glass from the heights of 25 cm, 50 cm, 75 cm, 100 cm and 125 cm. 3 test pieces were used in the drop test 15 for each height. The results are shown in Table 1. In Table 1, ◯ indicates no test piece fractured, Δ indicates part of the test pieces fractured, and × indicates all of the test pieces fractured.

TABLE 1

| | 25 cm | 50 cm | 75 cm | 100 cm | 125 cm |
|---|---|---|---|---|---|
| Example c | ◯ | ◯ | ◯ | Δ | X |
| | | | | 1 test | |
| | | | | piece | |
| | | | | fractured | |
| Example d | ◯ | ◯ | ◯ | ◯ | Δ |
| | | | | | 1 test |
| | | | | | piece |
| | | | | | fractured |
| Example e | ◯ | ◯ | ◯ | ◯ | X |
| Comp. | ◯ | ◯ | Δ | X | X |
| Example c | | | 2 test | | |
| | | | pieces | | |
| | | | fractured | | |
| Comp. | ◯ | X | X | X | X |
| Example d | | | | | |
| Comp. | Δ | X | X | X | X |
| Example e | 2 test | | | | |
| | pieces | | | | |
| | fractured | | | | |

As seen from Table 1, the test pieces of rare earth element-containing glass strengthened by forming a rare earth element high-concentration layer according to the present invention (Examples c, d and e) suffered no fracture by drop of the steel ball from the heights of up to 75 cm, with only one test piece being fractured by drop of the steel ball from the height of 100 cm in Example c. Two test pieces fractured in Comparative Example c by drop of the steel ball from the height of 75 cm, and all the test pieces fractured in all of the Comparative Examples by drop of the steel ball from the greater heights. This indicates that the glass having a rare earth element high-concentration layer according to the present invention has far higher strength than the glass samples of the Comparative Examples.

As viewed above, the glass according to the present invention has required strength even if small in thickness, and when it has a large thickness, its safety and reliability are appreciably increased. Thus, the scope of use of the present invention is not limited to the electronic devices such as panel glass for FPD and solar batteries; the invention can be applied as well to the fields of buildings, vehicles, aircraft, spacecraft, etc.

Here, the results of the tests on impact fracture resistance of the laminated glass (glass laminates) according to the present invention are explained. The compositions of the test pieces and the glass materials are the same as used in the impact fracture tests on the single-layer glass described above, viz. glass C (67 wt % SiO₂, 4 wt % Li₂O, 8 wt % Na₂O, 1 wt % K₂O, 15 wt % Al₂O₃, 2 wt % ZnO and 3 wt % Gd₂O₃), but the amount of the materials melted was about 17 kg and the melting conditions were 1,500° C. and 6 hours (of which 3.5 hours was used for glass homogenization by stirring). The melt was cast into a mold to make an approximately 150 mm×150 mm×220 mm glass block, and it was gradually cooled at 550° C. over a period of 3 hours at a cooling rate of 1° C./min and straightened.

The following 3 different test pieces were cut out from the said glass block and subjected to optical polishing:

Test piece for single layer glass: 150 mm×150 mm×3.0 mm

Test piece for 2-layer glass: 150 mm×150 mm×1.5 mm

Test piece for 3-layer glass: 150 m×150 mm×1.0 mm

As the strengthening treatment, a rare earth element (Gd) high-concentration layer was formed at the surface portion of the glass, as in the case of glass C described above.

After forming the chemically strengthened layer, a synthetic resin EVA (ethylene-vinyl acetate copolymer) was sandwiched between the test pieces for 2-layer glass and pressed together to make a 2-layer laminated glass, which was presented as “Example v”. EVA was also sandwiched between the respective test pieces for 3-layer glass and pressed together to make a 3-layer laminated glass, which was presented as “Example x”. The attached layer thickness was about 0.3 mm. The test piece for single-layer glass is intended for comparison with the laminated glass, and it is designed so that the overall thickness of glass exclusive of the resin will be equal to the thickness of 2-layer laminated glass (1.5 mm+1.5 mm=3.0 mm) and the thickness of 3-layer laminated glass (1.0 mm+1.0 mm+1.0 mm=3.0 mm). This glass is represented by “Example u”.

Table 2 shows the results of the impact facture test by drop of a steel ball on the 2-layer and 3-layer glass laminates, along with the test results on the test piece for single-layer glass with the same thickness. The mass of the steel ball used was 1.2 kg. This test was also a test according to JIS C8917 in which, with the layout described above, a steel ball of 1.2 kg in mass was dropped onto the test piece from the heights of 25 cm, 50 cm, 75 cm, 100 cm, 125 cm and 150 cm. Three test pieces were used in the drop test for each height. In Table 2, ◯ indicates no test piece fractured, Δ indicates part of the test pieces fractured, and × indicates all of the test pieces fractured.

TABLE 2

| | 25 | 50 | | | | |
|---|---|---|---|---|---|---|
| | cm | cm | 75 cm | 100 cm | 125 cm | 150 cm |
| Example u: | ◯ | ◯ | X | X | X | X |
| single- | | | Scattering | Scattering | Scattering | Scattering |
| layer | | | and | and | and | and |
| | | | falling | falling | falling | falling |
| | | | occurred | occurred | occurred | occurred |
| Example v: | ◯ | ◯ | ◯ | X | X | X |
| 2-layer | | | | No | No | No |
| laminate | | | | scattering | scattering | scattering |
| | | | | and | and | and |
| | | | | falling | falling | falling |
| Example x: | ◯ | ◯ | ◯ | ◯ | Δ | X |
| 3-layer | | | | | (2 test | No |
| laminate | | | | | pieces | scattering |
| | | | | | fractured) | and |
| | | | | | No | falling |
| | | | | | scattering | |
| | | | | | and | |
| | | | | | falling | |

As seen from the results shown in Table 2, the laminated glass formed by using the rare earth element-containing glass according to the present invention (Examples v and x) is appreciably strengthened in comparison with the single-layer glass (Example u) of the same thickness, and even if such laminated glass is fractured, there takes place no scattering of its fragments.

The present invention described above may be summarized as follows.

In the present invention, a rare earth element high-concentration layer is formed at the surface portion of a glass containing a rare earth element. The presence of this high-concentration rare earth element-containing layer serves for inhibiting the microcracks from growing to the larger cracks when a flexural stress is exerted to the glass. Since formation of this high-concentration layer does not resort to alkali ion exchange in the surface portion of the glass, there is no need of incorporating an alkali in the glass to be strengthened.

As the rare earth element, Pr, Nd, Sm, Eu, Gd, Tb, Dy, Ho, Er, Tm, Yb and Lu can be used, of which Eu, Gd, Dy, Tm, Yb and Lu are preferred, with Gd being the most preferred. The glass containing Eu, Gd, Dy, Tm, Yb or Lu has high light transmittance in the visible light region, and especially the glass using Gd is capable of satisfying, quite remarkably, both requirements for high strength enhancing effect and high light transmittance in the visible light region.

The scope of use of the glass member according to the present invention is not limited to the structural components of the display devices such as FPD and the glass structural members of electronic devices such as substrates of magnetic discs; the glass of the present invention can be also applied widely to the other objectives such as structural materials and window glass (including 2-layer glass and laminated glass) of buildings, substrates for solar batteries, structural members and window glass of vehicles, aircraft, spacecraft, etc., for which high strength and reduction of size and weight are required.

In the following, an example of flat panel display (FPD) which is one of the most promising fields of application of the glass of the present invention is explained.

As one of the self-emission type FPD having an electron source arranged as a matrix, there are known field emission displays (FED) and electron emission displays utilizing the cold cathodes capable of integration with low power. For these cold cathodes, there are used, for instance, spindt type electron source, surface conduction type electron source, carbon nanotube type electron source, metal-insulator-metal (MIM) laminate type, metal-insulator-semiconductor (MIS) laminate type, and metal-insulator-semiconductor-metal type thin-film electron sources.

Self-emission type FPD has a display panel comprising a back panel provided with electron sources such as mentioned above, a front panel provided with phosphor layers and an anode issuing an accelerating voltage for bombarding the electrons emitted from the electron sources, and a sealing frame for sealing the inside space between the two opposing panels in a prescribed evacuated state. The back panel has the said electron sources formed on a back substrate, and the front panel has the phosphor layers formed on a front substrate and an anode issuing an accelerating voltage for forming an electric field for bombarding the electrons emitted from the electron sources against the phosphor layers. A drive circuit is combined with this display panel. Usually, the back panel, front panel and sealing frame are made of glass. By using the said glass of the present invention for these parts, it is possible to realize an FPD which is small in size and weight and resistant to breakage.

Each electron source makes a pair with a corresponding phosphor layer to constitute a unit picture element. Usually, one pixel (color pixel) is composed of unit picture elements of three colors, viz. red (R), green (G) and blue (B). In the case of color pixel, the unit picture element is also called sub-pixel.

The front and back panels are separated by a member called spacer to keep a prescribed space between them. This spacer is a plate-like member made of an insulating material such as glass or ceramic or a material having a certain degree of conductivity, and it is provided for each group of pixels at a position where it will not hinder the movement of the pixels. By using the glass of the present invention for this spacer, it is possible to realize a thin, light-weight and breakage-resistant FPD.

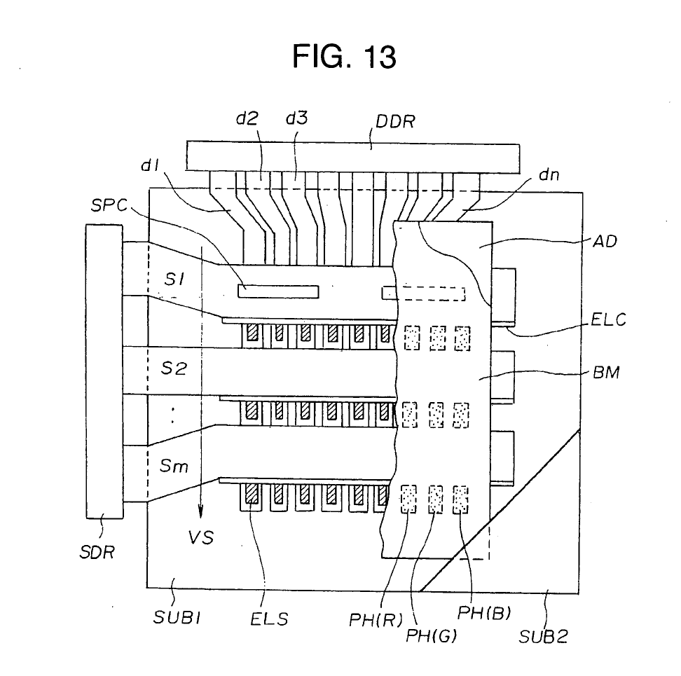

FIG. 13 is a diagrammatic plan showing the structure of a display device using the glass according to the present invention. The back substrate SUB1 of the back panel is made of the glass according to the present invention. Picture signal lines d (d1, d2, . . . dn) are formed on the inner surface of the substrate, and scanning signal lines s (s1, s2, s3, . . . sm) are formed thereon crossing the lines d. The picture signal lines d are driven by a picture signal drive circuit DDR, and the scanning signal lines s are driven by a scanning signal drive circuit SDR. In FIG. 13, spacers SPC are provided above the scanning signal line s1, and the electron sources ELS are provided on the downstream side of the spacers SPC in the vertical scanning direction VS. Power is supplied from the connecting electrodes ELC through the scanning signal lines s (s1, s2, s3, . . . sm). These spacers SPC are also made of the glass of the present invention.

The front substrate SUB2 of the front panel is made of the glass according to the present invention. An anode electrode AD is provided on the inner surface of the substrate, and phosphor layers PH (PH(R), PH(G), PH(B)) are formed on said anode electrode AD. With this arrangement, the phosphor layers PH (PH(R), PH(G), PH(B)) are comparted by a light shielding layer (black matrix) BM. The anode electrode AD is shown as a solid electrode, but it may be constituted as stripe electrodes arranged to cross the scanning signal lines s (s1, s2, s3, . . . sm) and divided for each row of pixels. The electrons emitted from the electron sources ELS are accelerated and bombarded against the phosphor layers PH (PH(R), PH(G), PH(B)) constituting the corresponding sub-pixels. Consequently, the said phosphor layers PH emit light with a prescribed color and it is mixed with the color of the light emitted from the phosphor of the other sub-pixels to constitute a color pixel of a prescribed color.

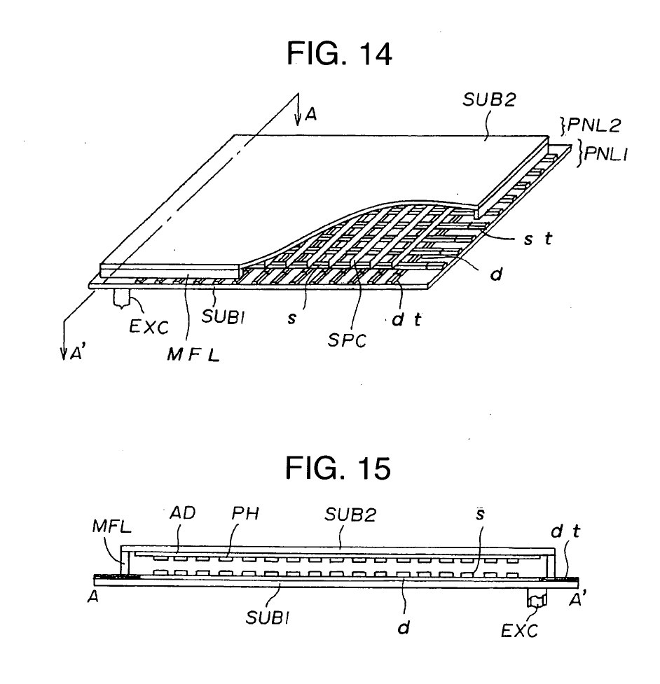

FIG. 14 is a perspective view showing the whole structure of the FED explained with reference to FIG. 13, and FIG. 15,is a sectional view thereof. FIG. 15 shows a glass section cut parallel to the spacers SPC which are not shown in the drawing. On the inner surface of the back substrate SUB1 of the back panel PNL1, there are provided picture signal lines d and electron sources disposed close to the crossings of the matrices of scanning signal lines s. Picture signal lines d are led out to the outside of the sealing frame MFL to form leader terminals dt. Similarly, scanning signal lines s are also lead out to the outside of the sealing frame MFL to form leader terminals st. On the other hand, an anode AD and phosphor layers PH are provided on the inner side of the front substrate SUB2 of the front panel PNL2. Anode AD comprises an aluminum layer.

The front panel PNL2 and the back panel PNL1 are opposed to each other, and in order to keep a prescribed space between them, the rib-like spacers SPC of approximately 80 μm in width and approximately 2.5 mm in height are provided above and in the extending direction of the scanning signal wiring and secured in position by using fritted glass or other means. A glass-made sealing frame MFL is provided at the peripheral edges of both panels and fixed in position by fritted glass (not shown) so that the internal space held by both panels will be isolated from the outside.

For fixing the spacers with fritted glass, they are heated at 400-450° C., and then the system is evacuated to about 1 μPa through an evacuating tube 303 and then sealed. In operation, a voltage of about 5-10 kV is applied to the anode AD on the front panel PNL2.

It should be further understood by those skilled in the art that although the foregoing description has been made on embodiments of the invention, the invention is not limited thereto and various changes and modifications may be made without departing from the spirit of the invention and the scope of the appended claims.

1. A process for producing a glass member, which comprises the steps of:
transferring a rare earth element contained in a base glass to a direction of a surface of a glass member to form a glass member containing a rare earth element.

2. The process according to claim 1 wherein said base glass contains said rare earth element in an amount of 1 to 10% by weight calculated as an oxide thereof Ln₂O₃, wherein Ln is the rare earth element.

3. The process according to claim 1 wherein said base glass contains said rare earth element in an amount of 2 to 7% by weight calculated as an oxide thereof Ln₂O₃, wherein Ln is the rare earth element.

4. The process according to claim 1 wherein said step of transferring a rare earth element is carried out by heating the base glass in magnetic field.

5. The process according to claim 1 wherein said rare earth element is at least one element selected from the group consisting of Pr, Nd, Sm, Eu, Gd, Tb, Dy, Ho, Er, Tm, Yb and Lu.

6. A process for strengthening a glass member, which comprises the step of:
heating a base glass containing a rare earth element to transfer the rare earth element contained in the base glass to a direction of a surface of a glass member.

7. A process for strengthening a glass member, which comprises the steps of:
transferring a rare earth element contained in a base glass to a direction of a surface of a glass member to form a strengthened glass member containing a rare earth element.

8. The process according to claim 7 wherein said base glass contains said rare earth element in an amount of 1 to 10% by weight calculated as an oxide thereof Ln₂O₃, wherein Ln is the rare earth element.

9. The process according to claim 7 wherein said base glass contains said rare earth element in an amount of 2 to 7% by weight calculated as an oxide thereof Ln₂O₃, wherein Ln is the rare earth element.

10. The process-according to claim 7 wherein said step of transferring a rare earth element is carried out by heating the base glass in magnetic field.

11. The process according to claim 7 wherein said rare earth element is at least one element selected from the group consisting of Pr, Nd, Sm, Eu, Gd, Tb, Dy, Ho, Er, Tm, Yb and Lu.
